(19) United States
(12) Patent Application Publication
(10) Pub. No.: US 2005/0131855 A1
(43) Pub. Date: Jun. 16, 2005

(54) Data cleaning

(76) Inventors: George Henry Forman, Port Orchard, WA (US); Bin Zhang, Fremont, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/733,750

(22) Filed: Dec. 11, 2003

(51) Int. Cl. G06F 7/00

(52) U.S. Cl. 707/1

(57) ABSTRACT

A process for rapid data recovery, data cleaning and an automated self-maintenance of the data recovery mechanism is provided. Dirty input data records are used in conjunction with and to build and revise a fast indexing table wherein index keys point to clean data records with which the input data should be rightly associated. Mechanisms for automated revision of the indexing table are described. Said table forms a tool useful in data mining and knowledge discovery to analysis of heuristic processes.

### BACKGROUND

1. Technical Field

The disclosure relates generally to data mining and knowledge discovery and more particularly to data cleaning and heuristics related thereto.

2. Description of Related Art

Along with the revolutionary advancements in commercial and private enterprises brought about by the introduction of the personal computer have come new problems. Particularly with respect to the Internet, both electronic commercial exchanges, also known as “E-commerce,” and direct business-to-business electronic data processing, have led to decreasing quality control with respect to data records received from other parties. For example, in traditional systems, only a company's employees had authority to enter data directly into an established database in accordance with rules generally designed to optimize data storage and recovery. Now, in order to speed processes, remote access to a database may be granted to a plurality of persons or entities, e.g., clients, customers, vendors, and the like, who may be using a plurality of different software programs or simply may be ignoring the data requirements intended by the associated company. As a result, the database may contain duplicative and erroneous data which must be “cleaned.” “Data cleaning,” or “data cleanup,” are the terms of art generally used to refer to the handling of missing data or identifying data integrity violations, where “dirty data” is a term generally applied to input data records which may have anomalies, e.g., the input data records may not conform to an expected format or standard for the established database. A simple example is when a store employee processing a credit card charged purchase uses an input data field intended for one purpose, e.g., the purchaser's name, for another, e.g., the purchaser's name and telephone number.

In the main part, heuristic-type programs try each of several methods of solving a problem and judging whether it is closer to solution after each attempt. For example, in order to tally up annual sales data by state, one must first determine the state for each sale. In cases where the state data is entered wrongly, thus being invalid data, or is entirely missing, and causing an anomaly for the established database, a routine may be implemented to infer the state data from a series of heuristics, such as: (1) if a sales record reports only a zip code, a cross-reference table can pull-up a unique city and state; and (2) if a sales record reports a city name but no zip code, the state may be determined if it is unique to the U.S., e.g., Seattle, Wash., but not for common city names such as “Franklin,” which exists in 27 states. It can be recognized from this simple example that to clean even a single field of a data record may involve a large number of heuristics and database relational processing. This leads to data processing resource issues as the central processing unit and memory unit have finite capacities.

Further, duplicative and erroneous data also leads to other data storage capacity issues. Errors in one database are likely to propagate to other databases and to do so repeatedly, cascading the aforementioned problems. For example, a typographical error in a zip code stored for the configuration of a credit card point-of-sale computer terminal will be repeated with each credit card transaction processed on that terminal. Furthermore, for the sort of data required in the exemplary credit card purchase transaction, the terminal user may be a sales clerk rather than a data processing expert, the data field intended formats may be regularly violated, e.g., the City Field being used for a telephone number or the like. In other words, in many such situations, there is little or no data quality control at the source of data input.

Having individuals dedicated to cleaning data is relatively expensive and tedious work. Also, it is inevitable that manual data cleaning will still result in some errors. Even given a program using heuristics to improve data storage, such programs are also prone to errors. For example an assumption type heuristic rule:
IF City=St. Louis→State=MO,
   may later be discovered to be in error since there is a St. Louis in Oklahoma. While these may be discovered over time by human review, it can still be difficult to determine the association rule or rules that caused the error and to resolve the error for the program.

Thus, data cleaning and development of heuristic rules are important tasks where automation to reduce otherwise manual labor tasks of repeatedly reviewing and correcting data records can be valuable. Advancement to heuristic programs can be improved by providing practitioners with better tools for rule development, deployment, and revision. In addition, goals of the data processing and heuristic programs should be toward reducing computing resource demands for data cleaning with respect to recurring errors.

### BRIEF SUMMARY

The invention generally provides for data cleaning and development of heuristic processes.

The foregoing summary is not intended to be inclusive of all aspects, objects, advantages and features of the present invention nor should any limitation on the scope of the invention be implied therefrom. This Brief Summary is provided in accordance with the mandate of 37 C.F.R. 1.73 and M.P.E.P. 608.01(d) merely to apprise the public, and more especially those interested in the particular art to which the invention relates, of the nature of the invention in order to be of assistance in aiding ready understanding of the patent in future searches.

### BRIEF DESCRIPTION OF THE DRAWINGS

FIG. 1 in accordance with a first exemplary embodiment of the present invention is a schematic system diagram.

FIG. 2 is a simplified system and process diagram in accordance with the exemplary embodiment of the present invention as shown in FIG. 1.

Like reference designations represent like features throughout the drawings. The drawings in this specification should be understood as not being drawn to scale unless specifically annotated as such.

### DETAILED DESCRIPTION

For the purpose of describing the present invention, an exemplary embodiment relating to a “Merchant Database” such as might be maintained by a credit card company will be employed. No limitation on the scope of the invention is intended by the applicant by the use of this convenience nor should any be implied therefrom.

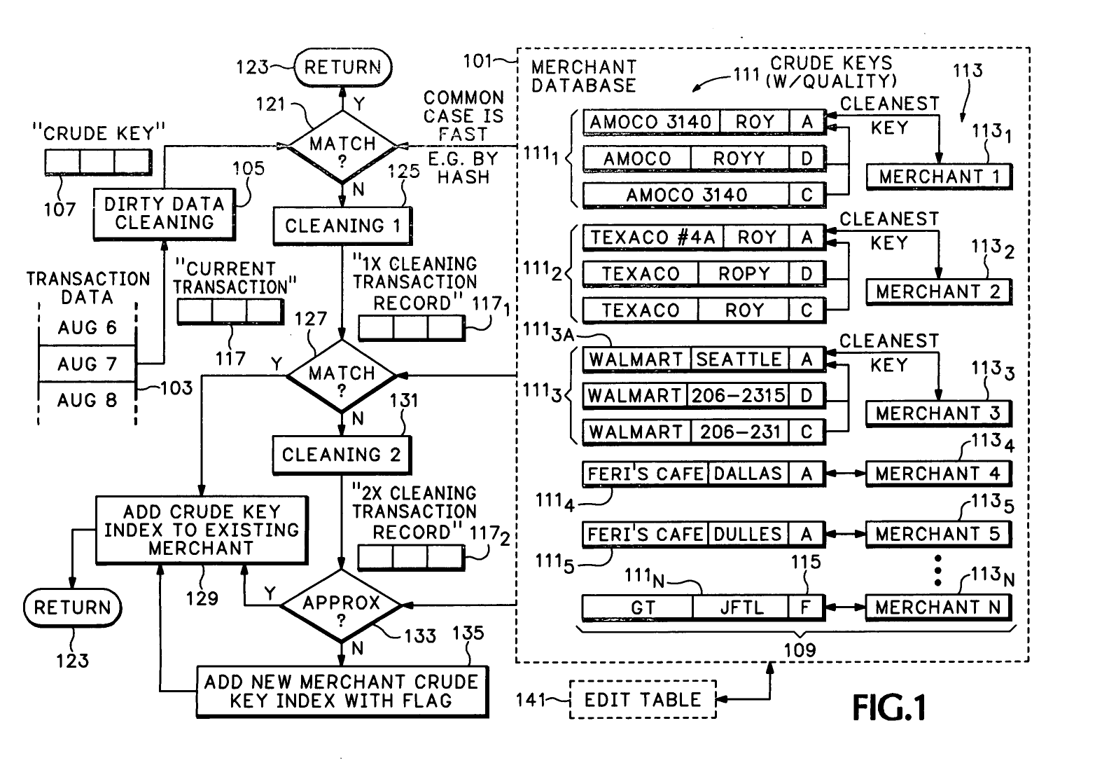

FIG. 1 illustrates a system 100 in accordance with such an exemplary embodiment.

A credit card company maintains a “Merchant Database” 101. Credit card “Transaction Data” 103 is received and logged on a predetermined schedule, e.g., hourly, daily (shown) or the like. In accordance with this exemplary embodiment of the present invention, a.“Crude Key” data cleanup process 105 is applied to the Transaction Data 103. For the main part, instead of considering data cleaning as one large monolithic process, it may be broken into progressive cleaning phases. Optionally, an initial cleaning process may be used for semi-homogenizing incoming data records by typical clean-up routines, e.g., removing white spaces, removing illegal characters, and the like.

A currently-to-be-reviewed data record of a set of incoming data—e.g., a first credit card transaction data record for August 7^{th} Transaction Data 103—initially is labeled a “crude key” in that the transaction data should but may not include all expected basic information such as a merchant name, merchant ID, and location, e.g., city, state and zip code. This crude key data record may be analyzed as is for a fast match-up to the appropriate merchant record 113 in the Merchant Database 101 and a relational persistent table 109 kept therewith.

The persistent table 109 is maintained preferably for the Merchant Database 101 in a displayable format. The persistent table 109 keeps and maps crude key indexing data records, referred to hereinafter more simply as the “crude key indices” 111, for a merchant to a completely clean record 113 for that merchant. It will be recognize by those skilled in the art that the “clean records” for purpose of implementation may be only a “cleanest key”—the most accurate crude key of a plurality of crude keys—where that “Merchant #” record 113 contains a pointer to a “cleanest key” 111_{1A} related full file for that respective merchant in tertiary memory. For the purpose of explaining this embodiment, the persistent table 109 is assumed to be adapted for producing the full, clean data, merchant file itself. Thus, for example, assume “Merchant 1” 113₁ is an “Amoco” gasoline station, having an assigned identification number “3140,” located in the city of “Roy,” with a given street address, city name, 9 digit zip code, state name, telephone number, facsimile machine number, proprietor's name, credit rating, Social Security number, and the like, information that a credit card company would keep on-file in a semi-permanent data record 113, or “file,” for each of its thousands of authorized merchant sites, Merchants 113₁ . . . 113_{N}, where the company's credit cards may be used by purchasers. Each Merchant's clean semi-permanent data record 113 is created, for example, when the merchant applies for and becomes an authorized merchant of the credit card company.

When a current transaction data record 117 is received by the credit card company, or when logged if batched for a predetermined time period first, that record is compared 121 to the crude key indices 111 first. This comparison should be accomplished as quickly as possible to conserve processing resources, for example in a known manner such as by hashing the current transaction data record 117 against the persistent table having the crude key indices. If a match is found 121, YES-path—for example if a match can be recognized between the current transaction data record 117 and a specific crude key index 111_{3A}—the first cleaning phase is a null and “Merchant 3” 113₃ is assigned immediately for the transaction, and the cleanest record known for that merchant is returned. Again, each crude key record may act as an index, or pointer, to the full data record for the appropriate associated merchant. Note that in order to save space for dealing with large tables, a 64-bit hash code signature of the crude key index record may be used; that is, the table is indexed only by the hash code instead of the crude key index records themselves, reducing the amount of data to store, although having an attendant loss of information. The process 107 returns 123 to select the next transaction data record for August 7^{th} to be the next current transaction data record 117 under consideration.

If no match is found, 121, NO-path, a first phase data cleaning algorithm, “Cleaning 1” 125, is applied to the current transaction data 117. After the raw match 121 attempt, each cleaning phase should not be a null. Such cleaning programs may be proprietary or can be obtained commercially, such as the Merlin Merge™ software by Intelligent Search Technologies Ltd. company, of Brewster, N.Y., http://www.intelligentsearch.com, Further explanation of the details of such programs is not necessary to an understanding of the present invention. After application of “Cleaning 1” 125, the once-cleaned current transaction data record 117₁ is stored temporarily, preferably as part of the Merchant Database 101 computing resources.

Another matching between the cleaned record 117 and the crude key indices 111 is performed 127. If a match is found, 127, YES-path, the transaction is assigned to the appropriate “Merchant #” and a new crude key index is generated 129, using the once-cleaned current transaction data record 117₁, which is added to the crude key indices set for that known merchant, see e.g., set of three indices 111₁for “Merchant 1” 113₁.

It may be advantageous to add an optional quality indicator 115 to each crude key so generated. For example, being an unrecognized record in the first crude key match 121 attempt, the assigned crude key 111ₙ may be given a initial low quality rating “F.” Once multiple crude key indices 111 are assigned, different quality ratings, e.g., “A” through “F,” may be assigned based on recognized accuracy. Accuracy and rating can be determined either by a system administrator's deductive analysis of a printout of the table 109 or automated by computerized probability and statistics algorithms. Further explanation of such is not necessary to an understanding of the present invention. In a given set, crude keys subordinate to the cleanest key may point to the cleanest key which most efficaciously points to the associated merchant record.

The process 107 returns 123 to select the next transaction data record for August 7^{th} to be the current transaction data record 117 under consideration.

If match is not found, 127, NO-path, for the once-cleaned current transaction data record 117₁, as above described, a second phase cleaning 131, may be applied to the stored once-cleaned current transaction data record 117₁ and the results, twice-cleaned current transaction data record 117₂, is stored temporarily again. It can now be recognized that the cleaning and match steps may be repeated until such time as further analysis would not be a profitable use of computing resources. After some predetermined phases of cleaning, a diminished-returns phase is reached. Assume for this exemplary embodiment that after application of two data cleanup operations 125, 131 that no further cleaning attempts are deemed appropriate. In general, the crude key index table may be repeatedly checked for matches between cleaning phases to short-circuit any remaining phases. Generally, the more data cleaning applied in the first phase 125, the less variation there should be in the generated crude key indices 111 and the smaller the persistent table 109 storage requirements.

After the last, e.g., herein the second, phase cleaning 131, a check 133 of the twice-cleaned current transaction data record 117₂ may be performed to determine if an approximate match in the crude key indices 111 of the table 109 can be found. The criteria for approximating a match can be selected as appropriate to any particular implementation. If an approximate match is determined, 133, YES-path, again a new crude key index is generated 129, optionally assigned a quality score, and added to the set of crude key indices 111 for that known merchant 113. The process 107 repeats 123 for the next current transaction data record 117. If an approximate match is not found, 133, NO-path, a record is generated 135 adding the merchant as a new merchant, “Merchant N” 113_{N}, along with an associated new crude key index 111_{N} based on 129 selected fields of the current transaction data record 117. Preferably, a flag is set on this new merchant record so that a system administrator can investigate the lack of a previous semipermanent record 113 for the new merchant 113_{N}.

It should be recognized by those skilled in the art that additional flags may be set on certain defined table entries to enable more detailed tracing and statistics collection. When an association is used that has such flags set, additional debugging or performance tuning information may be generated.

While it is not probable to forecast all possible inputs and input errors, the crude key index records 111 may be pre-populated by the system administrator with one or more exemplary records when entering a new merchant's semipermanent file 113, or they may be spontaneously generated with each transaction analysis, or both. For example, when adding “Merchant 4” 113₄ to the Merchant Database 101, the system administrator might create a simple, mapped crude key index 111₄, “Feri's Café, Dallas,” even though no transactions have yet occurred. As described hereinbefore, as Transaction Data 103, 117 is analyzed 107, new crude key records 111 are added where appropriate; e.g., when a transaction is received for the first time with data for “Merchant 1” 113₁ with a mis-spelling of the city as “Royy” instead of “Roy.”

Also note that iterative crude key analysis may be applied in multiple places in the data clean-up process. For example, one implementation may be applied for
(name, city, state, zip code, country)→MerchantID
   association, pointing to a unique entry in a merchant table that has the clean data record, while another implementation may be applied for
(city)→(city, state, country, zip, name)
   association.

In addition to the crude key index process 107 being a mechanism for improving data cleaning, a display or printout of the database 101 itself is a valuable tool in accordance with the present invention. For example, persons skilled in the art of data storage, data mining, knowledge discovery, and the like, can review such a table format as a visualization tool to better understand how implemented heuristic rules for the given database 101 are performing in practice, e.g., what data transformations they are executing. Note that traditional caching techniques are not open to inspection and are not used to reflect on the computations being performed.

As another option, an additional column or set of columns could be added to such a table format which can record the cleaning heuristics that were involved in generating each crude key index and record matching. Again, a person skilled in the art can recognize errors and improvements for heuristic associations so made.

An optional direct editing 141 of the table may be employed. For example, exceptions may be programmed into the compiling and comparison algorithm. Suppose that a rule,
IF City=St. Louis→State=MO,
   is frequently useful, but for a single merchant “Mr. Culbert,” who is in St. Louis, OK 74866, whose business-to-business software only presents a city name the assumption is wrong. Rather than remove the rule affecting all records related to “St. Louis,” the system administrator, or appropriately adapted data clean-up program, can insert an exception Crude Key→Clean Key into the persistent association table,
“Culbert, St. Louis, ______ “→” Mr. Culbert, St. Louis, OK, 74866.
   Note that the administrator need not identify the rule(s) at fault nor how to recompile rules software nor even how to program. They may perform table updates while the program is operational.

Alternatively, an implementation can be programmed to add recognized transforms directly into the crude key indexing table, injecting instances of knowledge discovery rather than using generalized rules. For example, one may write a script to search for all “clean keys” in a zip code, e.g., “74866,” that have a State mistakenly “corrected” to a State, e.g., “MO,” and change the “clean key” State “OK.”

Another option is to use date-stamping, time-stamping, with each record in the table to track most recent use. This information is traditionally used in traditional cache systems to eliminate records fallen into disuse. Unlike traditional cache systems, entries that have been entered or edited may receive special flags indicating that the association should not be purged as readily as those in such traditional automatic mechanisms. Tertiary storage may be employed for information not used for a predetermined period to save direct access memory resources.

Any input data records which are suitable for analysis with respect to clean data records in a memory may be analyzed and cleaned in accordance the present invention process as described hereinbefore. Moreover, whenever changes 129, 135 to the table, are implemented during a particular analysis operation, or on another basis such as a regular upgrade schedule, the aforementioned aspects of the table 109 as a tool may regularly checked by an algorithm adapted for searching for anomalies, such as duplications or the like described hereinabove. If anomalies are discovered, appropriate rules of such a program may be implemented until the review is completed.

One check and update process which may be implemented, for example, is to statistically determine how often each crude key index record 111 is a hit when the first match operation 121 is executed. The quality factor is then adjusted accordingly; represented in FIG. 1 by the arrow labeled “cleanest key.”

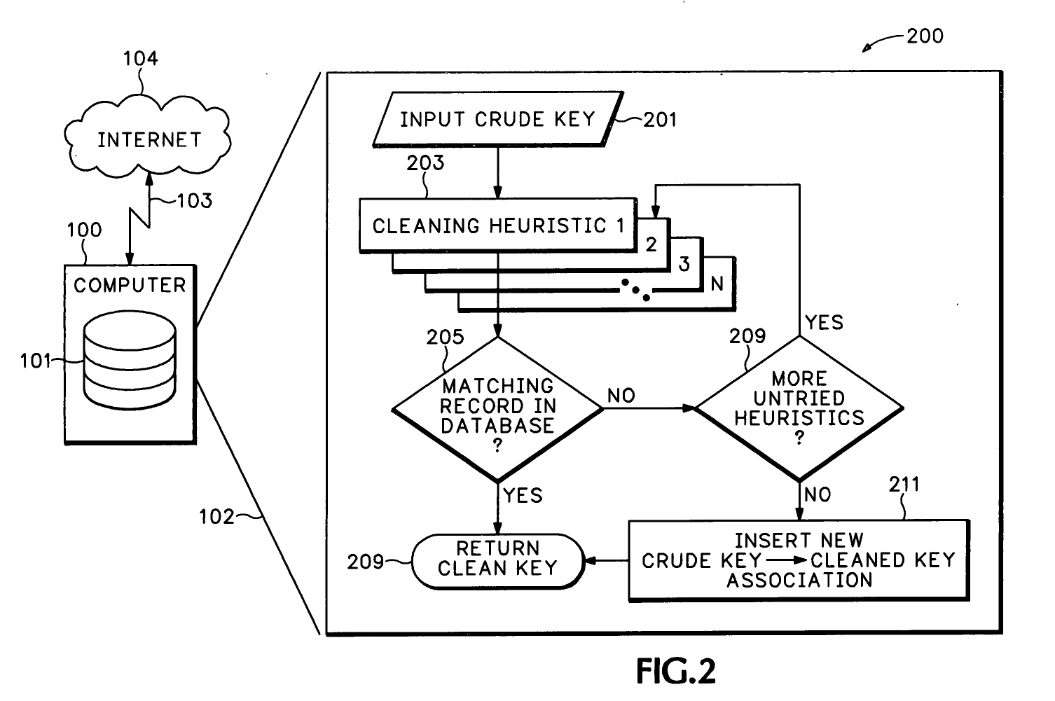

FIG. 2 is a simplified system and process diagram in accordance with the exemplary embodiment of the present invention as shown in FIG. 1 in a more generic exemplary embodiment form. A computing apparatus 100, running (illustrated by the blow-up line 102) a program 200, includes a memory 101 and a connection 103 to the Internet 104, or other network system. A Crude Key, “Input Crude Key,” 201 is received. A first cleaning heuristic routine, “Cleaning Heuristic 1,” 203 is applied. The database in memory 101 is compared 205, searching for a match, “Matching Record in Database?” If a match is discovered, 205, YES-path, the Clean Key associated in the database is returned, “Return Clean Key,” 207, ending the processing for the “Current Transaction” 117, FIG. 1. If the comparison 205 to the database does not produce a match, 207, NO-path, a determination, “More Untried Heuristics?”, 209 may be made as to whether there are more cleaning heuristic routines 203 available to be tried. In other words, as with FIG. 1, there may be a phased sequence of cleaning routines, shown in FIG. 2 as “Cleaning Heuristic 1,” “Cleaning Heuristic 2,” “Cleaning Heuristic 3,” through “Cleaning Heuristic N.” If there are more routines 203 than the most recently applied cleaning heuristic routine, 209, YES-path, then the next phase, e.g., “Cleaning Heuristic 2,” 203 is run for a match determination 205. If the most recent cleaning heuristic routine 203 was the last in the set, e.g., “Cleaning Heuristic N,” 209, NO-path, then the Crude Key 201 is added 211 to the database in memory 101 as a new “Cleanest Key,” “Insert New Crude Key→Cleanest Key Association.”

Any input data records which are suitable for analysis with respect to clean data records in a memory may be analyzed and cleaned in accordance the present invention process as described hereinbefore. Moreover, whenever changes 129, 135 to the table, are implemented during a particular analysis operation, or on another basis such as a regular upgrade schedule, the aforementioned aspects of the table 109 as a tool may regularly checked 141, FIG. 1, by an algorithm, “Edit Table,” adapted for searching for anomalies, such as duplications or the like described hereinabove. If anomalies are discovered, appropriate rules of this editing program are implemented until the review is completed.

In accordance with the foregoing exemplary embodiment, a process for rapid data recovery, data cleaning and an automated self-maintenance of the data recovery mechanism is provided. Dirty input data records are used to build a fast indexing table wherein index keys point to clean data records with which the input data should be rightly associated. Mechanisms for automated revision of the indexing table are described. Said table forms a tool useful in data mining and knowledge discovery to analysis of heuristic processes.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step(s) of . . . .”

1. A heuristics analysis tool comprising:
a persistent table, having clean data records and key records wherein there is at least one key record associated with each clean data record, said key record having at least one field of data from an associated said clean data record; and
associated with said key records, heuristic-based routines for automatically generating said key records from each newly received data record for matching to said clean data record.

2. The tool as set forth in claim 1 wherein said clean data record is a primary clean key record of a plurality of said key records in a set.

3. The tool as set forth in claim 2 wherein said primary clean key record is a pointer to a complete data file associated with a clean data record.

4. The tool as set forth in claim 1 wherein said clean data record is a primary complete clean data file.

5. The tool as set forth in claim 1 further comprising:
at least one column recording one or more of said heuristic-based routines that were involved in generating each of said key records.

6. The tool as set forth in claim 1 further comprising:
a time-stamp with each said key record in the table wherein said time-stamp indicative of most recent use.

7. The tool as set forth in claim 1 further comprising:
special flags associated with said key records, said flags associated with specific heuristic considerations.

8. The tool as set forth in claim 7 wherein a special flag is a quality factor assigned to each said key record.

9. A data association and cleaning method comprising:
storing a plurality of clean data files and, associated with each of said clean data files, at least one indexing record, each said indexing record containing at least one field related to a respective associated clean data file such that said at least one indexing record serves as a pointer to the respective associated said clean data file;
comparing incoming data records to the indexing records for obtaining a match, and assigning said input data record to the respective associated said clean data file associated with a matched indexing record;
if not obtaining a said match, iteratively cleaning input data until at least a near-match between said input data and said at least one indexing record is obtained and assigning said input data record to the one of said clean data files associated with a near-matched indexing record; and
upon a near match, adding a so-cleaned input data record as a new indexing record for an associated one of said clean data files, and upon no match, adding said so-cleaned input data record as a new clean data file with an associated indexing record therefor.

10. The method as set forth in claim 9 wherein said storing is in a displayable format.

11. The method as set forth in claim 10 further comprising:
at given intervals, performing a data clean-up on a stored table in said displayable format.

12. The method as set forth in claim 9 wherein upon said adding said so-cleaned input data record as a new clean data file with an associated indexing record therefor, flagging said new clean data file.

13. The method as set forth in claim 9, said iteratively cleaning further comprising:
upon said not recognizing a match therebetween, cleaning said input data and storing a first cleaned input data set;
comparing the first cleaned input data to each said indexing record, and
upon recognizing a match therebetween, stopping said comparing and retrieving the associated clean data for association with said input data,
upon not recognizing a match therebetween, re-cleaning said first cleaned input data, discarding said first cleaned input data, and storing a subsequently cleaned input data set;
re-comparing the subsequently cleaned input data set to said indexing record; and
iteratively repeating said re-cleaning and re-comparing until a predetermined phase of cleaning is reached without the said match therebetween wherein said a last said subsequently cleaned input data is stored as a new clean data file.

14. The method as set forth in claim 13 wherein upon said recognizing a match therebetween, a new indexing record is generated for said new clean data file.

15. A computer memory comprising:
computer code means for receiving input data records;
computer code means for comparing said input data records to a tabular format set of crude keys;
computer code means for returning a clean key associated with one of said crude keys upon a comparing match;
computer code means for iterative cleaning of said input data records upon a no-match return and storing an iteratively-generated respective cleaned data record therefrom;
computer code means for re-comparing said iteratively-generated respective cleaned data record to said set of crude keys, searching for said match return; and
computer code means for creating a new data file from a last said iteratively-generated respective cleaned data record such that said new data file is also a first respective one of said crude keys associated therewith.

16. The computer memory as set forth in claim 15 further comprising:
computer code means for generating a new crude key from an iteratively-generated respective cleaned data record.

17. The computer memory as set forth in claim 16 wherein said computer code means for generating a new crude key has heuristic routines.

18. The computer memory as set forth in claim 17 further comprising:
computer code means for displaying in said tabular format said crude keys and heuristic routines employed in said generating.

19. The computer memory as set forth in claim 15 wherein each of said crude keys has an associated pointer to obtain said associated clean key.

20. The computer memory as set forth in claim 17 wherein each of said crude keys points to a cleanest one of a plurality of crude keys associated with a clean data file.

21. The computer memory as set forth in claim 15 wherein said tabular array is a displayable table, comprising:
computer code means including heuristic routines for editing said table.

22. The computer memory as set forth in claim 15 wherein said tabular array is a displayable table comprising:
computer code means including heuristic routines for extending fields of data fields in said table.

23. A method of doing business comprising:
storing a database of clean data files for each of a plurality of entities;
creating a tabulation of crude keys, each having a pointer to an associated one of said clean data files;
receiving periodically a potentially dirty data record related to at least one entity of said plurality of entities;
comparing said dirty data to said array;
assigning said dirty data to one of said clean data files; and
creating new clean data files from said dirty data when no pointer substantially matching said dirty data is found during said comparing.
